(19) United States
(12) Patent Application Publication
(10) Pub. No.: US 2012/0138603 A1
(43) Pub. Date: Jun. 7, 2012

(54) VARIABLE GEOMETRY TORTILLA COOKING APPARATUS

(76) Inventors: Eugene T. McGuinness, Oceanside, CA (US); Morgan McGuinness, La Palma, CA (US)

(21) Appl. No.: 13/236,293

(22) Filed: Sep. 19, 2011

Related U.S. Application Data
(60) Provisional application No. 61/459,182, filed on Dec. 7, 2010.

(51) Int. Cl. H05B 6/80

(52) U.S. Cl. 219/725

(57) ABSTRACT

A configurable and variable geometric device for cooking tortilla shells evenly and to create a slight W-shape in the finished item. The W-shape formed in the crest of the cooked taco shell helps to make the taco shell self-standing. The cooking device is configurable from a flat position to a stand-up position having a top, a bottom, and sides. A plurality of apertures are on the peaks of the configured cooking device and along the sides the purpose of which is to allow full circulation of microwaves on the seated surface of a tortilla shell placed on the cooking device or member.

### CLAIM OF PRIORITY TO PRIOR APPLICATION

This application claims priority to provisional application having Ser. No. 61/459,182, entitled “Variable Geometry Mold for Cooking Taco Shells in Microwave Ovens or Conventional Ovens”, having a filing date of Dec. 7, 2010, which is herein incorporated by reference in its entirety.

### CROSS REFERENCES TO RELATED APPLICATIONS

This application is related to Ser. No. 11/742,869, entitled “Tortilla Cooking Apparatus”, having a filing date of May 1, 2007, which is herein incorporated by reference in its entirety.

### BACKGROUND

Eating and cooking tortillas, corn or flour, in their various forms be that as a taco, an enchilada, a tostada, a burrito, or any combinations of those and other forms of Mexican foods, has become extremely popular. So popular that such is no longer limited to specialty Mexican restaurants. Many non-Mexican themed fast-food establishments have also embraced the tortilla in its many forms.

Many large-chain supermarkets stock and sell various forms of tortilla shells for the home shopper. Such tortilla shells may be of the relatively fresh uncooked or partially cooked variety, pre-cooked or pre-formed variety, crisp variety, and the like. Pre-cooked and preformed may take the shape of a conventional U shaped taco shell to a fancy bowl-shape in which to place a salad, guacamole, frijoles (beans), or any other such treats or combinations thereof.

Uncooked tortilla shells are not generally suited for most Mexican-related meals. The most well recognized means of cooking tortilla shells by a home user are by frying the soft tortilla shell in a frying pan having a suitable shortening in it. Frying for a short period of time will render the cooked shell pliable. Frying for longer periods will render the cooked shell crisp and brittle. How fried and for how long will all depend on the individual tastes of the end user. For those preferring the crisp shell over the softer shell, cooking the tortilla shells is difficult. One must cook them in the oil and shape them while cooking until the desired shaped is accomplished. All the while during this cooking process, the user must be careful to create and maintain the desired shape while cooking and not to break the tortilla shell in the process.

Many innovations in tortilla-cooking devices and utensils have been made over the years due in large part to the rising popularity of foods involving the use of tortilla shells. Health-conscious diets caution against frying with shortenings and oils and other unhealthy ingredients. Some have even resorted to baking the tortilla shells to their liking thereby eliminating any undesirable qualities occasioned by use of any shortening or oil. Baking, however, is more time-consuming and consumes considerable energy in the process. Cooking tortilla shells in the microwave oven makes it extremely difficult to form and generally tends to render the cooked shell soggy and unappealing. If the tortilla shell is of the flour variety, in addition, it will blister and generally deform.

The foregoing has outlined some of the more pertinent objects of the tortilla cooking device of the present invention. These objects should be construed to be merely illustrative of some of the more prominent features and applications of the tortilla cooking device of the present invention. Many other beneficial results can be attained by applying the disclosed tortilla cooking device of the present invention in a different manner or by modifying the tortilla cooking device of the present invention within the scope of the invention. Accordingly, other objects and a fuller understanding of the tortilla cooking device of the present invention may be had by referring to the summary of the tortilla cooking device of the present invention and the detailed description of the preferred embodiment in addition to the scope of the tortilla cooking device of the present invention defined by the claims taken in conjunction with the accompanying drawings.

### SUMMARY

The above-noted problems, among others, are overcome by the tortilla cooking device of the present invention. This variable geometry tortilla cooking device of the present invention relates to an improvement in cooking tortillas, and more particularly to cooking tortillas in a more healthy fashion and shaping them into pre-formed taco shells and pre-formed tortilla-bowls. In a related embodiment, the variable geometry tortilla or flatbread cooking device is made from a disposable material that facilitates structurally configuring the cooking device from a flat state to a pop-up cooking device.

None of the innovations uncovered have been as innovative as the variable geometry tortilla cooking device of the present invention which, by using the microwave oven, can cook any variety of tortilla shells into the most commonly desired shapes to produce a more healthy and edible tortilla shell than previously capable. All this while preventing deformation and in the process minimizing the blistering effect as many of the flour variety are prone to do if cooked with any other cooking device in the microwave oven. The tortilla cooking device of the present invention directs microwave air flow in such a manner as to more evenly and fully cook the tortilla shell and limit blistering especially when cooking flour tortilla shells for tostada bowls. The mold for cooking tortilla shells into taco shells and the mold for cooking tortilla shells into tostada bowls are slightly different but are interchangeable for use with or without a base. In the various embodiments of the invention, the tortilla cooking device of the present invention is extremely easy to use, simple to manufacture, can be made in versatile shapes and is designed to be disposable.

In one example embodiment, the variable geometry tortilla or flatbread cooking device of the present invention contemplates a cooking device for tortilla shells to evenly cook and shape the tortilla shells into W-shapes for tacos or into bowl shapes for tostadas. In related embodiments, the geometric shape is selected from the group consisting of U-shape, V-shape, oval, round, triangle, square, round and corrugated versions of the aforementioned shapes. In one example embodiment, the cooking device has a first shaping member with a top, a bottom, a plurality of vertically disposed peaks from its bottom to its top, and a plurality of valleys adjacent to each said plurality of vertically disposed peaks. A plurality of apertures (or cut-outs) are on each of the peaks the purpose of which is to allow full circulation of microwaves on the seated surface of a tortilla shell placed on the first shaping member. Thereafter, with the tortilla or flatbread thereon, the cooking device is placed into a conventional microwave oven for heating and cooking with microwave energy to any desired flexibility, or crispiness causing the tortilla to retain its crisp defined shape. In a related embodiment, the construction material of the shaping member is modified to accommodate infrared radiation energy for cooking. In other related embodiments, the shaping member is configurable as described above to different shapes in order to generated different cooked tortilla configurations including, but not limited to, flat, round, oval, triangular, u-shaped, round bowl with corrugated edges and the like, and can be made to be disposable or of permanent material that is folding or flexible.

In a related embodiment, the variable geometry plate or form facilitates a cooking process for pizzas and in forming flat bread into shapes, such as taco shells and tortilla chips without using any fat oil or grease and can be used in a conventional oven or microwave oven. Since pizza is a very popular food item, and with the base of pizza being flat bread, the ability to cook it quickly without using any fat oil or grease is a benefit for the health-minded consumers

Flat breads also known as tortillas come in a variety of flavors and sizes which are used to make taco shells and tortilla chips and other dishes, but cooking the conventional way in a deep fat fryer is messy and adds a large amount of fat to the finished dish. Hence, with the variable geometry cooking system, no oil fat or grease is needed to form taco shells, tortilla chips, a fat free pizza crust and other shapes. In one example embodiment, the geometric cooking shape or member is made of FDA approved food grade plastic, which is dishwasher safe and stain resistance. In a related embodiment, the geometric cooking shape is made from a USDA approved material to allow it to be included with the flatbread or tortilla packaging.

In one example embodiment, the varying geometric cooking member consists of a flat plate or template when flat (in a non-configured state) evenly supports flatbread such as tortillas. The cooking plate includes finger-like structures consisting of numerous vent holes, the fingers being connectable or attachable in the middle of the plate by an axel that allows the plate to be hinged along the center, folding the plate in half. When the plate is in the stand-up (pop-up or configured position) position, a curved top is formed presenting a rounded surface at the apex of the fold for tortillas to be draped over. When the plate is in the stand-up position, the outer edges of the plate are also hinged. On both sides these edges act as feet to support the folded plate from falling over. Upon cooking the tortilla takes on the rounded shape forming taco shells or tortilla sliced into strips for tortilla chips.

In yet another embodiment, the cooking plate or member facilitates on both sides of the plate thereby forming flat bread into additional shapes such as rolled shapes for hot pocket sandwiches. Burritos can be made by folding the plate in the middle of the stand-up position and laying it on its side so as to form a rounded shape on the inside fold that holds the burrito. With this configuration, cooking rolled tacos, hot dogs pocket sandwiches or any cylindrical food item is facilitated.

The foregoing has outlined the more pertinent and important features of the tortilla cooking device of the present invention in order that the detailed description that follows may be better understood so the present contributions to the art may be more fully appreciated. Additional features of the tortilla cooking device of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the tortilla cooking device of the present invention. It also should be realized by those skilled in the art that such equivalent constructions and methods do not depart from the spirit and scope of the tortilla cooking device of the present invention as set forth in the appended claims.

### BRIEF DESCRIPTION OF THE DRAWINGS

For a fuller understanding of the nature and objects of the tortilla cooking device of the present invention, reference should be had to the following detailed description taken in conjunction with the accompanying drawings in which:

FIG. 1 is a top view of a configurable cooking plate in the unfolded or flat position.

FIG. 2 is a view of a support cross member shown in FIG. 1.

FIG. 3 is a bottom view of the plate folded or in the stand-up position.

FIG. 4 is a left side view of the plate in the flat position.

FIG. 5 is a right side view of the plate in the flat position.

FIG. 6 is a right side, stand-up view of the cooking template.

FIG. 7 is a top view of the plate folded or stand-up position.

FIG. 8 is a side view of the stand-up, configured position of the cooking template or member.

FIG. 9 is a top view of another embodiment of the cooking template.

### DETAILED DESCRIPTION

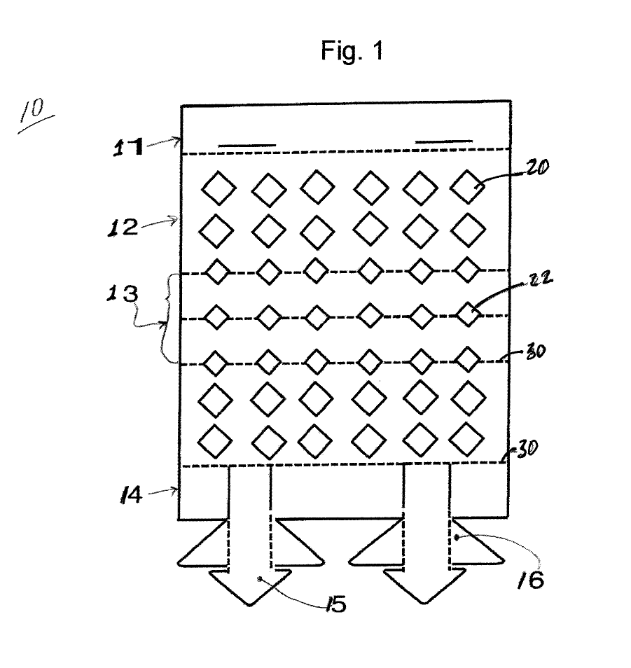

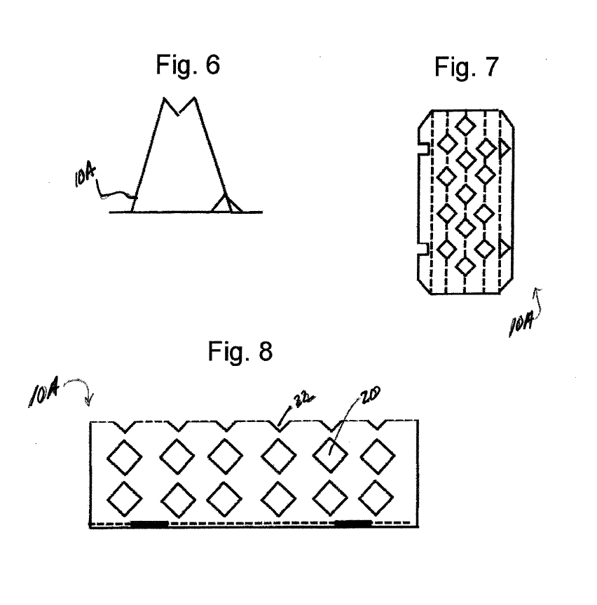

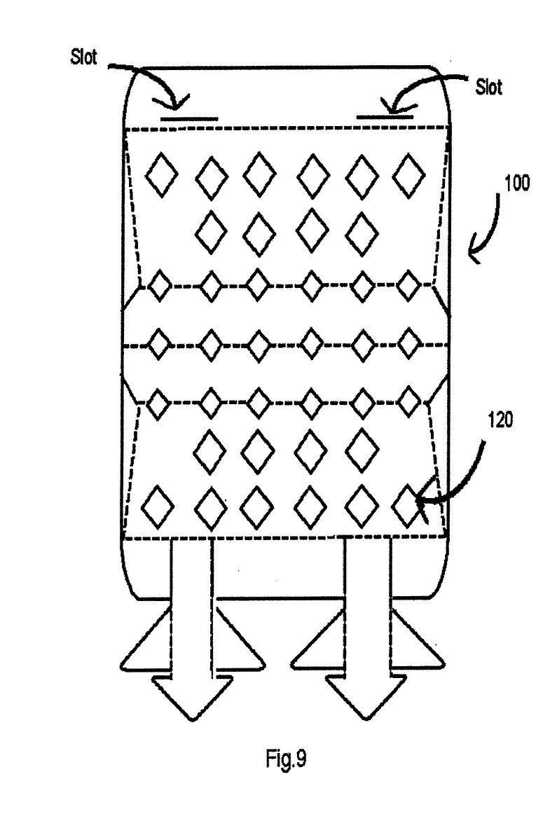

Referring now to the drawings generally FIGS. 1-8, reference character 10 generally designates an example embodiment of a tortilla (or flatbread) cooking system or apparatus of the present invention. Apparatus 10 is suited for cooking tortilla shells shaped for tacos or flatbread for pizza as non-limiting examples. In one example embodiment, once cooking apparatus 10 is configured in a stand-up position (see FIG. 8), a tortilla shell (not shown) is draped over configured device 10A and is then placed into a conventional microwave oven for cooking.

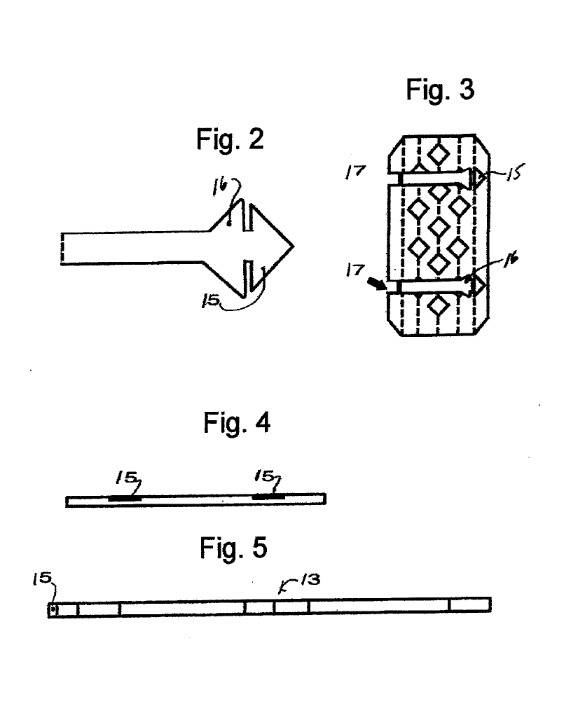

In FIG. 1, symmetrical plate 10 consists of four general portions 11-14 which are hinged together to allow folding, in this position the plate is substantial flat to provide a surface for a pizza or tortilla or flatbread to be cooked. Portion 11 includes slotted holes while portions 12 and 13 include a plurality of steam vent holes 20 and 22. Dotted lines 30 indicate folding lines for the configurable cooking device 10. Portion 14 has support tabs 15 protruding therefrom while support feet 16 protrude from support tab 15. FIG. 2 shows an enlarged support tab 15 with support feet 16. Tabs or arms 15 protrude horizontality intersecting beyond the center of the plate to allow more surface area overlapping in the middle of the plate.

In this example embodiment, a plurality of vent holes 20 and 22, of different sizes in this embodiment, are configured for the hot air to rise allowing cooking from both sides. In other example embodiments, the hole can be of various sizes, shapes, arrangements and locations to maximize cooking benefits. Space between the arms allows the free flow of hot air further improving the cooking from both sides and speeds up the cooking process. Embedded hinges attaching the main arms to the support feet run about one third of the radius of the plate.

In this example embodiment, an embedded center axel which the main arms pivot around these axels' vertical holes aligns with the holes on the arms when the plate is in the flat position. A hooked extending arm is not connected to the center axel to allow extra support in this portion of the plate. Hinged winged edges lays flat when the plate is in the flat position while vertical holes on arms which extends through the center axel when the plate is in the flat position allowing hot air to vent across the surface of the plate further to ensure even cooking. Vertical holes in support feet 16 are set at an angle so when the plate is folded or flat the vent holes are not blocked by the surface on which the plate is resting. Vertical indentation allows for maximum exposure for the flat bread to heat while still being supported.

A three quarter rounded shape on the center of the arms and flattop allows the plate to present a flat surface when in the flat position and a rounded top when in the stand-up position as in FIG. 3. The rounded shape forms the rounded shape in the middle of a taco shell when a tortilla is draped over the plate in the stand-up position. In this embodiment, the center axel allows the arms to pivot in a uniform manner around a center point giving a consistent shape when the plate is in a stand-up position or flat position. Vertical holes allow steam and hot air to escape during the cooking process, the holes become horizontal when the plate is in the stand-up position. Hinged winged edges with vertical feet allow the plate to fold in the center while the support feet remain in a vertical position to add stability to the plate while in the stand-up position. The feet are also the same vertical size as the middle rounded shape of the arms to allow even flat consistent support to the plate in the flat position, so the plate is not higher or lower in the middle when the plate is in the flat position.

Referring briefly to FIG. 3, the bottoms of the feet are substantially flat to prevent horizontal rocking of the plate in the flat position or in the stand-up position. The curved sides of the winged edges are to allow better airflow around the edge to more effectively crisp the edges of a flatbread to be used as the pizza crust. The angled vertical vent holes allow the hot air and steam to be vented up the pizza crust and not be blocked by the feet at the same time allowing even cooking. The center axel is a tight fit so when the plate 10 is lifted from the edges the middle will not sink down forming a pizza with a crease in the middle. Fold over points 17 from support members 15 are shown in FIG. 3.

Referring briefly to FIG. 8, the underside of the arms are shaped in a curve of a quarter circle so when the plate is in the stand-up position an inner half circle shape is formed allowing rolled tacos to be cooked and hot pocket sandwiches. The series of curves comprising mounds and valleys along the underside of the arms, this allows the plate to cook foods on both side of the surface when the plate is flipped in an flat position such foods as bacon can be cooked and the vent holes become drain holes for oil, grease of fat. The peaks of the mounds allow the food to sit above the oil grease or fat resulting in a meal with less fat. The upward sloping rounded edge allows a crisper cooked edge when cooking taco shells, or tortilla chips and for support for the uncooked tortillas as they form, without using more material in the manufacturing process.

In this example embodiment, the is open space since the view on either side the support arms are every other one this also allows better air flow thus more even cooking whether or not the plate in the flat position or stand-up position. The ends of the middle axel flush and smooth with the ends of the body to prevent tearing of soft tortillas and not interfere with the air flow around the edges. The ends of the outer hinges are flush and smooth with the ends of the body to prevent tearing of soft tortillas and not interfere with the airflow around the edges. When the plate is in the stand-up flat position the holes in the arms align with holes in the middle axel to allow airflow heat and moisture to escape. Each arm is curved along the length with a vent hole in the middle of the apex of the crest these holes allow heat moisture to escape forming a volcano effect along the length of the arms cooking the flat bread from both side whether the plate is in the stand-up position or flat position.

In yet another related embodiment, when the cooking plate is in the stand-up position but laying on its side the inside portion of the legs form a semi-circle this is the perfect area to form and cook rolled tacos or hot pockets sandwiches holding the food in place. The series of curves comprising mounds and valleys along the in the inside of the support arms allows larger foods such as burritos to be held in place and cooked from both sides.

In this example embodiment, when in the stand-up position, the crest of the cooking device forms a uniformed curved shape so when a tortilla is draped over the center and cooked it forms a perfect rounded taco shell.

In yet another embodiment, the support feet can rotate 90 degrees forming a right angle to the support arms in either direction, when the plate is in a stand-up position the feet face out ward supporting rest of the body. When the plate is in the stand-up position but lying on its side, the feet can be turned inward to lock in foods that are being cooked inside the support legs. Each arm is curved along the length with a vent hole in the middle of the apex of the crest these holes allow heat moisture to escape forming a volcano effect along the length of the arms cooking the flat bread from both side whether the plate is in the stand-up position or flat position. FIG. 3 shows how the center axel is recessed into the arms on each side. An adjustable locking feature is included that can set the varying desired widths for chosen foods.

In another embodiment (not shown), cooking template 10B is configurable to form an inverted U shape. It has a first side 12A and a second side 12B the tops of which are radially connected to each other thereby forming the inverted U-shape as the curved top. Consequently, as the tortilla shell, as draped over tortilla or flatbread cooking device of the present invention, cooks in a microwave oven, microwaves and air will vent up through and out of the plurality of apertures 20 and 22 in the walls and peaks of cooking device 10B. The plurality of apertures 22 causes the heating components of the microwaves to circulate evenly on the inside of the tortilla shell (that portion resting on and adjacent to the peaks).

The entire inner portion of the tortilla shell is so heated and cooked to virtually even perfection to the desired state of the user (from pliable to crisp or any variation in between). If cooked to a crisp state, the cooked tortilla shell will not only be properly and evenly cooked, but will retain the shape of the cooking device or member 10A when removed. When the tortilla shell is then inverted, it will resemble the familiar U shape suited for a taco and acceptance of fillings of the user's choice. In related embodiments, the tortilla or flatbread will take other shapes based on the configuration of configured member 10A.

FIG. 9 illustrates another embodiment of a tortilla or flatbread cooking device 100 of the present invention. Cooking device 100 also has a plurality of apertures 120 throughout for channeling the heat and steam during cooking.

In a related embodiment, devices 10 and 100 having these peaks and valleys render it well suited for cooking tortilla shells into tortilla chips. A tortilla would first by cut into desired shapes (triangular or strips, for instance), placed on either device 10 or 100 and then with cut up tortilla pieces placed into a microwave oven and cooked to desired crispness. The, peaks and valley on the base plate 20 serve to better circulate the microwaves for even cooking of the cut-up shells into uniformly crisp tortilla chips.

In various embodiments, the variable geometry cooking device or mold 10 can lay flat and even fold in sections creating a very small size for easy packaging and shipping. This also allows the tortillas to be cooked to form a taco shell in the stand-up position. Taco shells can be formed in a variety of opening sizes, by adjusting the distance between the support feet, forming a wider or thinner mold on which to cook the tortilla. The V-shaped grooved that is formed when it is in the stand-up position allows for more air flow and supports the tortilla evenly so as it cooks the tortilla will be balanced and not fall off the structure, this shape also allows the cooked taco shell to form a slight “W” shape along the crest of the shell the tips on the bottom of the “W” form feet which supports the shell evenly allowing the shell to be self-standing. A taco shell that stands up on its own makes an easy way for the filling to be added to the taco shell, without the need for extra support. The holes at the bottom of the valley and the top edges of the act as vents for the steam to be released cooking the tortilla from both sides. The feet along the base of each side of the structure keep it from falling over. While in the cooking process and further supports structure and the extra weight of a tortilla while cooking.

In various related embodiments, the cooking device described herein can cook into chips the following, but not limited to, tortillas, flatbread, pita bread, potatoes, yucca, apples and carrots, by positioning them in the vertical slots, or draping them over the top. This allows excellent exposure to heat and a support system if one desires to add spray on flavors, without the need to reposition the food. In addition, the cooking device in a flexible form can fold flat to reduce shipping cost, and can be designed of disposable material as well to reduce weight and cost. Hence, one could be packaged with the same bag or container as the tortillas (or other foods) on store shelves. In a related embodiment, the cooking device described herein allows the user to adjust the final width of the cooked taco shell and whether they want a traditional rounded taco shell or one that is self-standing.

In yet another related embodiment, the cooking device cooks ordinary sliced bread into crunchy toasted hot dog or sausage buns or U-shaped receptacles/ holders. There is no need to buy hot dog buns that tend to split into two pieces. With the cooking device, breakfast on the go is now an option or a snack as you can use breakfast sausage in place of hot dogs.

The present invention includes that contained in the present claims as well as that of the foregoing description. Although this tortilla cooking device of the present invention has been described in its preferred forms with a certain degree of particularity, it is understood that the present invention of the preferred forms has been made only by way of example and numerous changes in the details of construction and combination and arrangement of parts and method steps may be resorted to without departing from the spirit and scope of the tortilla cooking device of the present invention. Accordingly, the scope of the tortilla cooking device of the present invention should be determined not by the embodiment[s] illustrated, but by the appended claims and their legal equivalents.

Applicant[s] has attempted to disclose all of the embodiment[s] of the tortilla cooking device of the present invention that could be reasonably foreseen. It must be understood, however, that there may be unforeseeable insubstantial modifications to tortilla cooking device of the present invention that remain as equivalents and thereby falling within the scope of the tortilla cooking device of the present invention.

What is claimed is:

1. An apparatus for use in cooking flatbread in a microwave oven, the apparatus comprising:
a body having a length, a width, and a height, the body including alternating ridges and valleys disposed along at least a portion of the length of the body and extending transverse to the length of the body, each of the ridges and each of the valleys having two sides and a connecting portion connected to the two sides;
wherein the body has a non-uniform cross-sectional perimeter size along the length of the body, with a first cross-section transverse to the length of the body through one of the ridges along a peak of the ridge having a first substantially W-shaped perimeter of a first size, and a cross-section transverse to the length of the body through one of the valleys along its trough having a second substantially W-shaped perimeter of a second size, the first size being larger than the second size, and wherein the body is made of a flexible material to facilitate conversion from a substantially flat configuration to having the W-shaped perimeter configuration.

2. The apparatus of claim 1 wherein each of the ridges provides wholly within the ridge at least one aperture configured to allow steam to pass from the flatbread, when disposed on the body and cooked in a microwave oven, through the at least one aperture.

3. The apparatus of claim 1 wherein each of the ridges provides a plurality of apertures disposed along a length of the ridge.

4. The apparatus of claim 3 wherein each of the ridges provides the apertures along the peak of the ridge.

5. The apparatus of claim 1 wherein the body consists of material selected from the group consisting of microwave-safe, disposable, infrared-safe, dishwasher safe, cardboard, paper, and wax-coated paper material.

6. The apparatus of claim 1 wherein the substantially W shaped body has a base portion and two side portions with proximal ends connected to the base portion and distal ends disposed remotely from the base portion, the proximal ends being closer to each other than the distal ends.

7. The apparatus of claim 1 wherein the ridges and valleys extend linearly transverse to the length and parallel to each other.

8. An apparatus for use in cooking a single tortilla in a microwave oven, the apparatus comprising:
a body having a length, a width, and a height, the body having two sides and a central portion connecting the two sides to receive the single tortilla such that the single tortilla has a substantially W shaped cross-section transverse to the length of the body when received by the body, the body including alternating ridges and recesses disposed along at least a portion of the length of the body such that the apparatus has a varying cross-sectional size along the length of the body;
wherein the recesses provide channels from the central portion of the body to ends of the sides whereby steam is channeled between the single tortilla and the apparatus away from the single tortilla when the single tortilla is received by the body and cooked in the microwave oven, and wherein the body is made of a flexible material to facilitate conversion from a substantially flat configuration to having the W-shaped perimeter configuration.

9. The apparatus of claim 8 wherein both the ridges and the recesses extend transverse to the length of the body.

10. The apparatus of claim 9 wherein each of the ridges provides within the ridge at least one aperture configured to allow steam to pass from the single tortilla through the apparatus when the single tortilla is disposed on the body and cooked in a microwave oven.

11. The apparatus of claim 1 wherein the body consists of material selected from the group consisting of microwave-safe, disposable, infrared-safe, dishwasher safe, cardboard, paper, and wax-coated paper material.
